(19) United States
(12) Patent Application Publication
(10) Pub. No.: US 2024/0221510 A1
(43) Pub. Date: Jul. 4, 2024

(54) METHOD AND SYSTEM FOR PREDICTING MULTI-HOP TURNAROUND TIME OPERATIONS IN AIRCRAFT

(71) Applicant: Tata Consultancy Services Limited, Mumbai (IN)

(72) Inventors: Sakthi Priya MANIVANNAN, Chennai (IN); Rashmi KUMARI, Bangalore (IN); Vijayarangan NATARAJAN, Chennai (IN)

(73) Assignee: Tata Consultancy Services Limited, Mumbai (IN)

(21) Appl. No.: 18/544,597

(22) Filed: Dec. 19, 2023

(30) Foreign Application Priority Data
Dec. 28, 2022 (IN) 202221076275

(51) Int. Cl. G08G 5/00

(52) U.S. Cl. CPC G08G 5/0034; G08G 5/0039

(57) ABSTRACT

This disclosure relates generally to method and system for predicting multi-hop turnaround time operations in aircraft. Airline industries demands dynamic improving turnaround operations efficiency with digitalization strategies. The disclosed method receives one or more flight events scheduled between a source and a destination. Further, constructs a statistical control chart by analyzing the outliers of each flight event and estimates a continuous improvement plan based on the statistical control chart and a power transformation of the actual TAT value. The air traffic delay model trained with a plurality of air traffic TAT delays predicts at every hop turnaround time operations delay of each flight leg movement. Additionally, predicts delay impacting air traffic network at current flight leg based on the turnaround time operations delay and determining scheduling status of each flight event based on a threshold delay for next flight leg execution.

### PRIORITY CLAIM

This U.S. patent application claims priority under 35 U.S.C. § 119 to: Indian Patent Application No. 202221076275, filed on Dec. 28, 2022. The entire contents of the aforementioned application are incorporated herein by reference.

### TECHNICAL FIELD

The disclosure herein generally relates to turnaround time, and, more particularly, to methods and systems for predicting multi-hop turnaround time operations in aircrafts.

### BACKGROUND

The Airline industry is focusing on improving aircraft turnaround efficiency by minimizing the time taken to perform turnaround activities during the entire journey of aircraft. Turnaround time has a significant impact in terms of marketability and value creation potential of an aircraft, and for this reason, it is considered as an important driver which reduces cost of an aircraft's journey. Software applications being utilized in the airline industry are complex. Flight delays are one of the most important factor because they cause a lot of overhead costs to the airline industries.

Several complicated turnaround activities are coordinated between airports and the airline operators during the journey of the aircrafts. In such complex scenarios, airline industries demand dynamically adapting continuously changing processes related to compliance and regulatory for delivering operational efficiencies. Current available airline systems lack integrated turnaround monitoring and causality capturing environment which links all departments involved in the turnaround process. Furthermore, lack of visibility due to blind spots in the turnaround process leaves the airlines with a standardized approach to minimize delays and improve their on-time performance. The Airline industry is looking for industry proven solutions that can accelerate its digitalization journey for aircraft turnaround management with a platform that supports continuous improvement of airline processes.

### SUMMARY

Embodiments of the present disclosure present technological improvements as solutions to one or more of the above-mentioned technical problems recognized by the inventors in conventional systems. For example, in one embodiment, a system for predicting multi-hop turnaround time operations in aircraft is provided. The system includes receiving an input data comprising one or more flight events scheduled between a source and a destination, wherein each flight event includes one or more hops and determining a scheduled turnaround time (TAT) value from outliers of each flight event.

Further, a statistical control chart is constructed construct by analyzing the outliers of each flight event based on at least one of (i) if a standard deviation is lower than absolute difference between the baseline TAT value and a moving central line of the actual TAT value by using a plurality of turnaround parameters actual TAT value by using a plurality of turnaround parameters, and (ii) if the standard deviation exceeds absolute difference between the baseline TAT value and the moving central line of the actual TAT value by using a plurality of baseline turnaround parameters.

In one embodiment, a station level TAT outlier data corresponding to each hop of each flight event are determined based on the statistical control chart. Then, a continuous improvement plan is estimated based on (i) the statistical control chart, (ii) a plurality of influencing controllable factors, (iii) a plurality of influencing uncontrollable factors, and (iv) a power transformation of the actual TAT value.

In accordance with an embodiment, a performance chart of each flight event is constructed by, determining one or more on-time performance parameters (OTP) of each flight event from the statistical control chart and computing a coefficient of variation (CoV) of the OTP based on a ratio of average OTP and a standard deviation of the OTP. Further, a maximum OTP of each flight event is determined based on (i) the coefficient of variation of the OTP, (ii) an improved OTP, and (iii) the one or more OTP, wherein the improved OTP is a sum of the OTP and the plurality of influencing controllable factors, and a one or more uncontrollable activities are computed by estimating the improved OTP and limits of the plurality of influencing uncontrollable factors based on the maximum OTP and the improved OTP.

In accordance with an embodiment a coefficient of association is of each flight event is computed between a previous hop of the OTP and the scheduled turnaround time (TAT) value based on a plurality of attributes.

In accordance with an embodiment predicting at every hop turnaround time operations delay of each flight leg movement based on an air traffic delay model trained with a plurality of air traffic TAT delays.

In accordance with an embodiment, predicting delays impacting air traffic network at current flight leg based on the turnaround time operations delay and determining scheduling status of each flight event based on a threshold delay for next flight leg execution by estimating (i) an estimated time of departure (ETD) of current flight leg using a current flight leg data, (ii) an estimated time of departure time (ETD) of current flight leg using a previous leg data and the current flight leg data, and (iii) an estimated time of arrival (ETA) of the current leg data.

In another aspect, a method for predicting multi-hop turnaround time operations in aircraft is provided. The method includes predicting multi-hop turnaround time operations in aircraft is provided. The system includes receiving an input data comprising one or more flight events scheduled between a source and a destination, wherein each flight event includes one or more hops and determining a scheduled turnaround time (TAT) value from outliers of each flight event. Further, a statistical control chart is constructed construct by analyzing the outliers of each flight event based on at least one of (i) if the standard deviation is lower than absolute difference between the baseline TAT value and a moving central line of the actual TAT value by using a plurality of turnaround parameters actual TAT value by using a plurality of turnaround parameters, and (ii) if the standard deviation exceeds absolute difference between the baseline TAT value and the moving central line of the actual TAT value by using a plurality of baseline turnaround parameters.

In one embodiment, a station level TAT outlier data corresponding to each hop of each flight event are determined based on the statistical control chart. Then, a continuous improvement plan is estimated based on (i) the statistical control chart, (ii) a plurality of influencing controllable factors, (iii) a plurality of influencing uncontrollable factors, and (iv) a power transformation of the actual TAT value.

In accordance with an embodiment, a performance chart of each flight event is constructed by, determining one or more on-time performance parameters (OTP) of each flight event from the statistical control chart and computing a coefficient of variation (CoV) of the OTP based on a ratio of average OTP and a standard deviation of the OTP. Further, a maximum OTP of each flight event is determined based on (i) the coefficient of variation of the OTP, (ii) an improved OTP, and (iii) the one or more OTP, wherein the improved OTP is a sum of the OTP and the plurality of influencing controllable factors, and a one or more uncontrollable activities are computed by estimating the improved OTP and limits of the plurality of influencing uncontrollable factors based on the maximum OTP and the improved OTP.

In accordance with an embodiment a coefficient of association is of each flight event is computed between a previous hop of the OTP and the scheduled turnaround time (TAT) value based on a plurality of attributes.

In accordance with an embodiment predicting at every hop turnaround time operations delay of each flight leg movement based on an air traffic delay model trained with a plurality of air traffic TAT delays.

In accordance with an embodiment predicting delays impacting air traffic network at current flight leg based on the turnaround time operations delay and determining scheduling status of each flight event based on a threshold delay for next flight leg execution by estimating (i) an estimated time of departure (ETD) of current flight leg using a current flight leg data, (ii) an estimated time of departure time (ETD) of current flight leg using a previous leg data and the current flight leg data, and (iii) an estimated time of arrival (ETA) of the current leg data.

In yet another aspect, a non-transitory computer readable medium for the system includes predicting multi-hop turnaround time operations in aircraft is provided. The system includes receiving an input data comprising one or more flight events scheduled between a source and a destination, wherein each flight event includes one or more hops and determining a scheduled turnaround time (TAT) value from outliers of each flight event. Further, a statistical control chart is constructed construct by analyzing the outliers of each flight event based on at least one of (i) if the standard deviation is lower than absolute difference between the baseline TAT value and a moving central line of the actual TAT value by using a plurality of turnaround parameters actual TAT value by using a plurality of turnaround parameters, and (ii) if the standard deviation exceeds absolute difference between the baseline TAT value and the moving central line of the actual TAT value by using a plurality of baseline turnaround parameters.

In one embodiment, a station level TAT outlier data corresponding to each hop of each flight event are determined based on the statistical control chart. Then, a continuous improvement plan is estimated based on (i) the statistical control chart, (ii) a plurality of influencing controllable factors, (iii) a plurality of influencing uncontrollable factors, and (iv) a power transformation of the actual TAT value.

In accordance with an embodiment, a performance chart of each flight event is constructed by, determining one or more on-time performance parameters (OTP) of each flight event from the statistical control chart and computing a coefficient of variation (CoV) of the OTP based on a ratio of average OTP and a standard deviation of the OTP. Further, a maximum OTP of each flight event is determined based on (i) the coefficient of variation of the OTP, (ii) an improved OTP, and (iii) the one or more OTP, wherein the improved OTP is a sum of the OTP and the plurality of influencing controllable factors, and a one or more uncontrollable activities are computed by estimating the improved OTP and limits of the plurality of influencing uncontrollable factors based on the maximum OTP and the improved OTP.

In accordance with an embodiment a coefficient of association is of each flight event is computed between a previous hop of the OTP and the scheduled turnaround time (TAT) value based on a plurality of attributes.

In accordance with an embodiment predicting at every hop turnaround time operations delay of each flight leg movement based on an air traffic delay model trained with a plurality of air traffic TAT delays.

In accordance with an embodiment predicting delays impacting air traffic network at current flight leg based on the turnaround time operations delay and determining scheduling status of each flight event based on a threshold delay for next flight leg execution by estimating (i) an estimated time of departure (ETD) of current flight leg using a current flight leg data, (ii) an estimated time of departure time (ETD) of current flight leg using a previous leg data and the current flight leg data, and (iii) an estimated time of arrival (ETA) of the current leg data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of an example system for predicting multi-hop turnaround time operations in aircraft, in accordance with some embodiments of the present disclosure.

FIG. 2 illustrates an architecture of an example of the system predicting multi-hop turnaround time operations in aircraft, in accordance with some embodiments of the present disclosure.

FIG. 3A and FIG. 3B illustrates an example flow diagram for predicting multi-hop turnaround time operations in aircraft using the system of FIG. 1, in accordance with some embodiments of the present disclosure.

FIG. 4 illustrates an air traffic delay model trained to predict turnaround time operations delay of each flight at every hop in aircraft using the system of FIG. 1, in accordance with some embodiments of the present disclosure.

FIG. 5 illustrates an example method for predicting multi-hop turnaround time operations for one or more flight events scheduled between a source and a destination using the system of FIG. 1, in accordance with some embodiments of the present disclosure.

FIG. 6 illustrates an example method of the system predicting TAT delay over internet protocol (IP) based on machine learning (ML)/artificial intelligence (AI) and impacting air traffic network at current flight leg using the system of FIG. 1, in accordance with some embodiments of the present disclosure.

FIG. 7 illustrates graphical representation of a statistical control chart by analyzing outliers of each flight event using the system of FIG. 1, in accordance with some embodiments of the present disclosure.

FIG. 8 illustrates graphical representation of on-time performance parameters versus a plurality of controllable activities identified in the flight event using the system of FIG. 1, in accordance with some embodiments of the present disclosure.

FIG. 9 illustrates graphical representation of baseline outliers of turnaround time using the system of FIG. 1, in accordance with some embodiments of the present disclosure.

FIG. 10 illustrates graphical representation of power transformation of actual TAT value using the system of FIG. 1, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

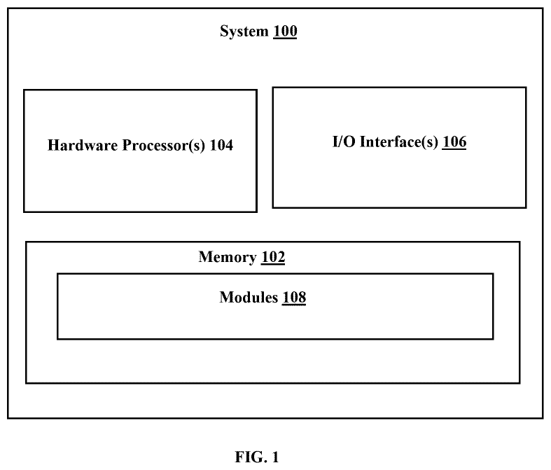

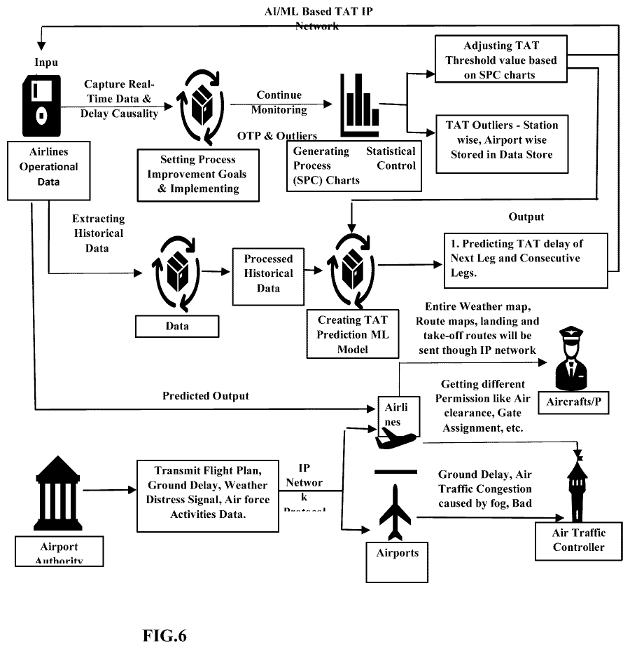

Embodiments herein provide a method and system for predicting multi-hop turnaround time operations in aircraft. The method disclosed, enables to predict turnaround time (TAT) operations delay of flight leg movement. Aircraft turnaround management is complex and involves cross-functional process(es) with multi-interdependencies. The key to airline efficiency depends on consistent on-time performance (OTP) with fine execution of aircraft turnaround management. Turnaround time (TAT) operations are a set of activities performed at airport, while monitoring the aircraft during the journey before takeoff. The method of the present disclosure identifies delay causalities impacting air traffic network with a systematic continuous improvement plan and a performance chart. Here, the scheduled turnaround time activities include for example an engine start, an aircraft arrival, and thereof. The method of the present disclosure provides a business ecosystem platform to drive the efficiencies with an end-to-end digital aircraft turnaround management solution. The disclosed system is further explained with the method as described in conjunction with FIG. 1 to FIG. 10 below.

Referring now to the drawings, and more particularly to FIG. 1 through FIG. 10, where similar reference characters denote corresponding features consistently throughout the figures, there are shown preferred embodiments, and these embodiments are described in the context of the following exemplary system and/or method.

FIG. 1 illustrates an exemplary block diagram of an example system for predicting multi-hop turnaround time operations in an aircraft, in accordance with some embodiments of the present disclosure. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud, and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random-access memory (SRAM) and dynamic-random access memory (DRAM), and/or non-volatile memory, such as read only memory (ROM), erasable programmable ROM, flash memories, hard disks, optical disks, and magnetic tapes. The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

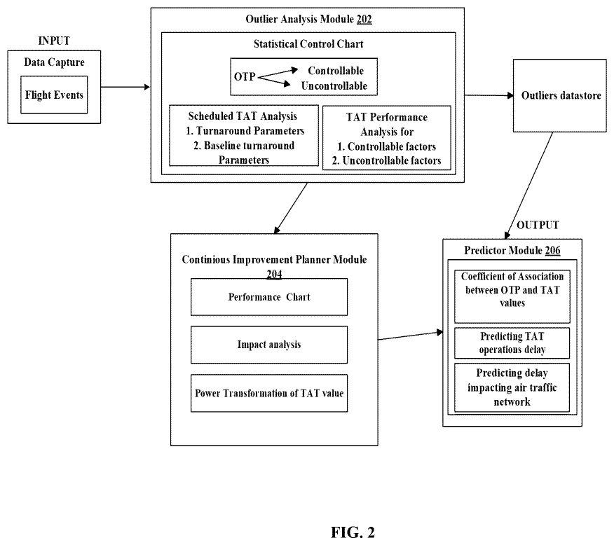

FIG. 2 illustrates the architecture of an example of the system predicting multi-hop turnaround time operations in aircraft, in accordance with some embodiments of the present disclosure. FIG. 2 includes an outlier analysis module 202, a continuous improvement planner module 204, and a predictor module 206.

The system 100 receives input data of each flight event scheduled between a source and a destination from an external sources. The received input data comprises one or more flight events for a journey scheduled between a source and destination, wherein each journey has one or more hops in between which are further processed by the outlier analysis module 202.

The outlier analysis module 202 analyses each flight events and constructs a statistical control chart. The statistical chart is constructed for two different conditions such as if a standard deviation is lower than absolute difference and exceeding the absolute difference.

The continuous improvement planner module 204 estimates the statistical control chart and power transformation of the actual TAT value and a performance chart is constructed for one or more on-time performance parameters (OTP) of each flight event for scheduling.

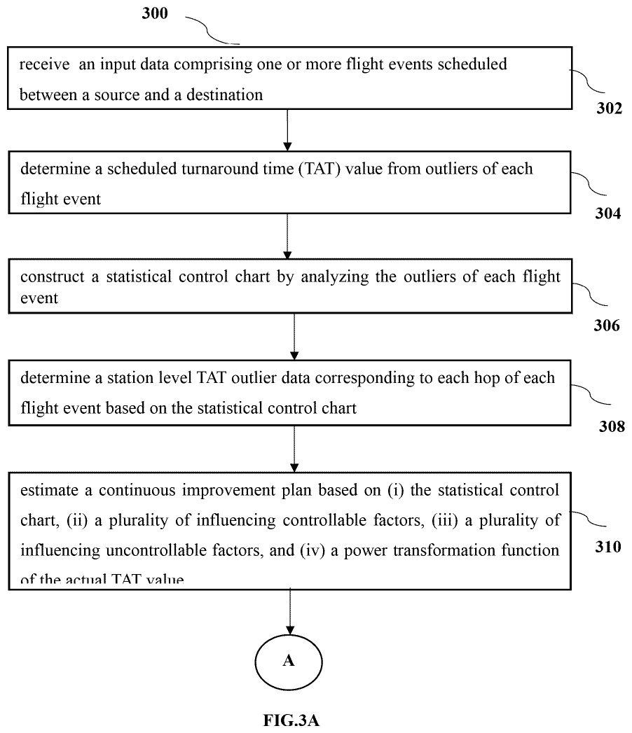

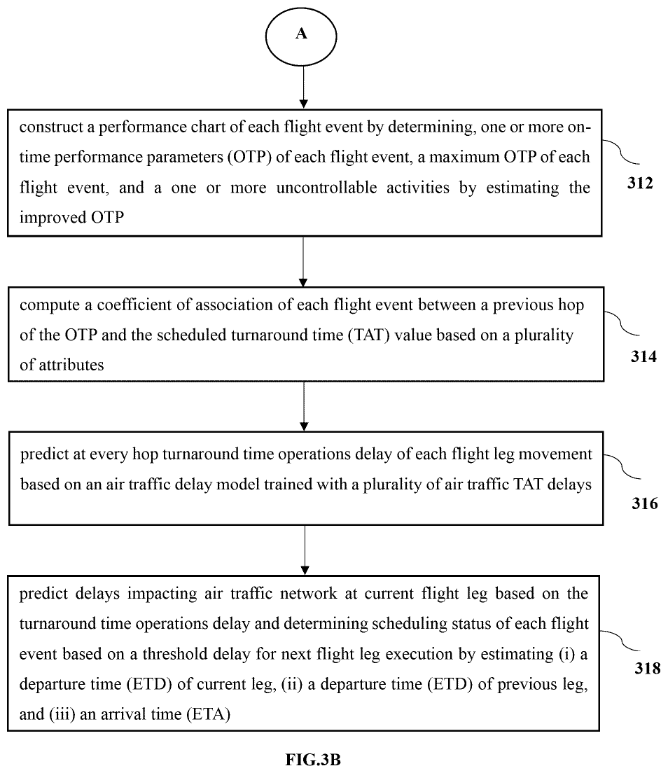

The predictor module 206 predicts turnaround time operation delay of each flight leg movement based on an air traffic delay model trained with a plurality of air traffic TAT delays. The predictor module also predicts delays impacting air traffic network at current flight leg based on the turnaround time operations delay and schedule status are evaluated. Functions of the modules for predicting delays in aircrafts, are explained in conjunction with FIG. 3 through FIG. 10 providing a flow diagram, architectural overviews, and performance analysis of the system 100.

FIG. 3A and FIG. 3B illustrates an example flow diagram for predicting multi-hop turnaround time operations in aircraft using the system of FIG. 1, in accordance with some embodiments of the present disclosure. In an embodiment, the system 100 comprises one or more data storage devices or the memory 102 operatively coupled to the processor(s) 104 and is configured to store instructions for execution of steps of the method 300 by the processor(s) or one or more hardware processors 104. The steps of the method 300 of the present disclosure will now be explained with reference to the components or blocks of the system 100 as depicted in FIG. 2 through FIG. 10. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring now to the steps of the method 300, at step 302, the one or more hardware processors 104 receive an input data comprising one or more flight events scheduled between a source and a destination, wherein each flight event includes one or more hops. In accordance with an example of the present disclosure, the system 100 monitors the scheduled turnaround time activities in the airport at every hop during the flight journey between the source and the destination. Each flight data includes a flight identifier relates to the wing of the aircraft, a flight leg identifier, a flight number relates to unique number identification for the definite journey, a flight date, an aircraft registration number, a departure station code, an arrival station code, a planned turnaround time, and an actual turnaround time.

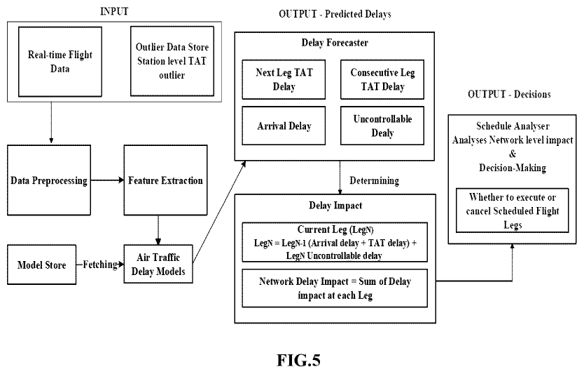

As an illustrative example (FIG. 5), for the purpose of explanation the system 100 during the journey the flight event includes one or more turnaround activities being performed at every hop in each flight. The one or more flight event includes a water filling, a cargo door open, a catering service, a fueling service, a chocks on, an initial walkaround check, a aerobridge or ladder aligned, a A/C door open, a holds open, a load instruction form (LIFB) initial to captain, a toilet, and water service, a cabin cleaning, a guest deplane, a boarding gate operations, a guest boarding at A/C, a load instruction form final to captain, a holds close, an ARC signed, a A/C door close, a final walkaround check, a aerobridge or ladder removed, chocks off, and the like.

Here, each flight event activities are dependent on each other, and the activity is represented as (Xᵢ) which is analytically converted into stochastic function with respect to time.
If (Xᵢ) is an independent activity, the scheduled turnaround time (TAT) processing time is represented as ƒ(Xᵢ)=tᵢ.
If (Xᵢ) is a dependent activity, the scheduled TAT processing time is represented as ƒ(Xᵢ)=t₁+t₂+t₃+ . . . +tⱼ.
   where, each t; is the scheduled processing time of activity (Xₖ), where k=1, 2, . . . j.

Every turnaround time (TAT) process is the execution time of activities that are not being performed within the predefined scheduled time at every hop in the airport. Sometimes, the scheduled time and an actual processing time of flight events differ either with early completion of the activity or with delay in execution. Stochastic variation present in the scheduled time and actual time performing each flight event, is represented with the variation λ. Here, g(Xᵢ) is the actual processing time of the flight event activity (Xᵢ), that is scheduled with processing time of Xᵢ+λ. In case of dependent activity (Xᵢ) is represented as the actual processing time of g(Xᵢ),

### Where,

$$g ( {X}_{i} ) = ( {t}_{1} + {λ}_{1} ) + ( {t}_{2} + {λ}_{2} ) + ( {t}_{3} + {λ}_{3} ) + … + ( {t}_{j} + {λ}_{j} ) and \\ g ( {X}_{i} ) - f ( {X}_{i} ) = {λ}_{1} + {λ}_{2} + {λ}_{3} + … + {λ}_{j}$$

which contributes on the crucial parts of the outliers.

Referring now to the steps of the method 300, at step 304, the one or more hardware processors 104 determine a scheduled turnaround time (TAT) value from outliers of each flight event. From the above step output, from each flight event the scheduled TAT values are determined from the outliers.

Referring now to the steps of the method 300, at step 306, the one or more hardware processors 104 construct, a statistical control chart is by analyzing the outliers of each flight event based on at least one of (i) if a standard deviation is lower than absolute difference between the baseline TAT value and a moving central line of the actual TAT value by using a plurality of turnaround parameters actual TAT value, and (ii) if the standard deviation exceeds absolute difference between the baseline TAT value and the moving central line of the actual TAT value by using a plurality of baseline turnaround parameters.

In one embodiment, the plurality of turnaround parameters comprises of a moving central line, an upper control limit (UCL) and a lower control limit (LCL). The upper control limit (UCL) includes a primary UCL₁ and a secondary UCL₂. The lower control limit includes a primary LCL₁ and a secondary LCL₂.

In one embodiment, the plurality of baseline turnaround parameters comprises of a baseline upper control limit (UCL) and a baseline lower control limit (LCL). The baseline upper control limit (UCL) includes a first UCL₁ value, a second UCL₂ value, a third UCL₃ value, and a fourth UCL₄ value. The baseline lower control limit (LCL) includes a first LCL₁ value, a second LCL₂ value, a third LCL₃ value, and a fourth LCL₄ value.

In one embodiment, the statistical control chart is constructed for the standard deviation lower than absolute difference between the baseline TAT value and a moving central line of the actual TAT value by using a plurality of turnaround parameters by computing the primary upper control limit (UCL) and the secondary upper control limit (UCL) based on the plurality of turnaround parameters.

The primary upper control limit (UCL₁) is a mean value of the actual TAT value summed with a ratio of moving range mean value of a predefined value is represented in Equation 1,

$${UCL}_{1} = Mean + ( 3 * Mean of MR ) / 1.128 \qquad Equation 1$$

The secondary upper control limit (UCL₂) is the mean value summed with a predefined number of times of standard deviation is represented in Equation 2,

$${UCL}_{2} = Mean + 3 * Standard Deviation \qquad Equation 2$$

The primary lower control limit (LCL₁) is the difference between a baseline TAT value with the ratio of moving range mean value of the predefined value is represented in Equation 3,

$${LCL}_{1} = Mean - ( 3 * Mean of MR ) / 1.128 \qquad Equation 3$$

The secondary lower control limit (LCL₂) is the difference between the actual TAT mean value and the predefined number of times of standard deviation is represented in Equation 4,

$${LCL}_{2} = Mean - ( 3 * Standard Deviation ) \qquad Equation 4$$

Further, the statistical control chart is constructed for the standard deviation exceeding absolute difference between the baseline TAT value and the moving central line of the actual TAT value by using a plurality of baseline turnaround parameters where, the first UCL₁ value based on the actual TAT mean value summed with the ratio of moving range mean value and the predefined value is represented in Equation 5,

$${UCL}_{1} = Mean + ( 3 * Mean of MR ) / 1.128 \qquad Equation 5$$

The second UCL₂ value is the actual TAT mean value summed with predefined times of standard deviation is represented in Equation 6,

$${UCL}_{2} = Mean + 3 * Standard Deviation \qquad Equation 6$$

The third UCL₃ value is the baseline TAT value summed with the ratio of baseline and mean of moving range value with the predefined number of times represented in Equation 7,

$${UCL}_{3} = Baseline + ( 3 * Mean of MR ) / 1.128 \qquad Equation 7$$

The fourth UCL₄ value is the baseline value summed with the predefined number of times of the standard deviation is represented in Equation 8,

$${UCL}_{4} = Baseline + 3 * Standard Deviation \qquad Equation 8$$

Further, the first LCL₁ value based on the difference between the actual TAT mean value and the ratio of moving range mean value with the predefined value is represented in Equation 9,

$${LCL}_{1} = Mean - ( 3 * Mean of MR ) / 1.128 \qquad Equation 9$$

The second LCL₂ value is the difference between the mean value and the predefined number of times of the standard deviation is represented in Equation 10,

$${LCL}_{2} = Mean - 3 * Standard Deviation \qquad Equation 10$$

The third LCL₃ value is the difference between the baseline TAT value with the ratio of moving range mean value of the predefined value is represented in Equation 11,

$${LCL}_{3} = Baseline - ( 3 * Mean of MR / 1.128 ) \qquad Equation 11$$

The fourth LCL₁₄ value is the difference between the baseline TAT value and the predefined number of times of standard deviation is represented in Equation 12,

$${LCL}_{4} = Baseline - 3 * Standard Deviation \qquad Equation 12$$

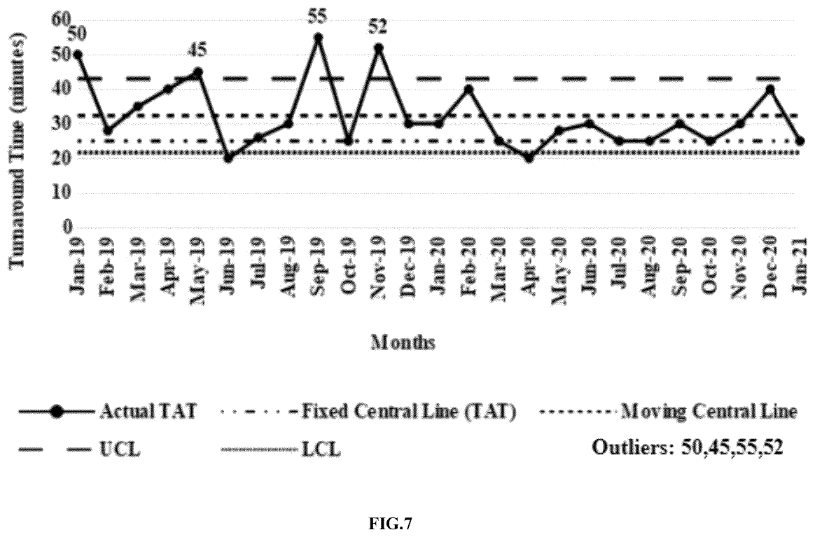

FIG. 7 illustrates graphical representation of a statistical control chart by analyzing outliers of each flight event using the system of FIG. 1, in accordance with some embodiments of the present disclosure. Here, the baseline TAT data advises the aircraft on its continuous improvement opportunities. Overtime when sufficient data is gathered, the outlier analysis is conducted for turnaround baseline process followed at each station and on different aircraft types.

Referring now to the steps of the method 300, at step 308, the one or more hardware processors 104 determine a station level TAT outlier data corresponding to each hop of each flight event based on the statistical control chart. At every station, for each flight based on the scheduled TAT value and the actual TAT value, UCL, LCL, and the moving central line is calculated, and the statistical charts are depicted. The actual TAT value of the flights greater than the UCL value will be considered as outliers.

Referring now to the steps of the method 300, at step 310, the one or more hardware processors 104 estimate a continuous improvement plan based on (i) the statistical control chart, (ii) a plurality of influencing controllable factors, (iii) a plurality of influencing uncontrollable factors, and (iv) a transformation function of the actual TAT value. With the help of historical actual TAT value, the UCL, the LCL, and the moving central line values are determined which improves the present TAT value of the aircraft by means of technical resources and controlling CPM activities. Further, the statistical analysis of the plurality of influencing controllable factors and the plurality of influencing uncontrollable factors are determined. Parallelly, simulated TAT value is computed using the power transformation on the actual TAT value for further analysis.

The plurality of influencing controllable factors includes for example an airport authority, a handling, a technical, and thereof. The airport authorities' problems due to runway capacities, occupied parking and thereof. The handling problems delayed ground processes such as late passengers, handling agent disposition. The technical problems such as malfunction of technical systems for example aircraft.

The plurality of influencing uncontrollable factors includes an air traffic flow management, weather condition, and other factors. The air traffic flow management factors such as restrictions according to crowed air traffic control sectors, traffic flow restrictions. The weather conditions such as negative weather influences such as rain, snow, wind and thereof. Other factors such as aircraft damage, strike, no delay code and thereof.

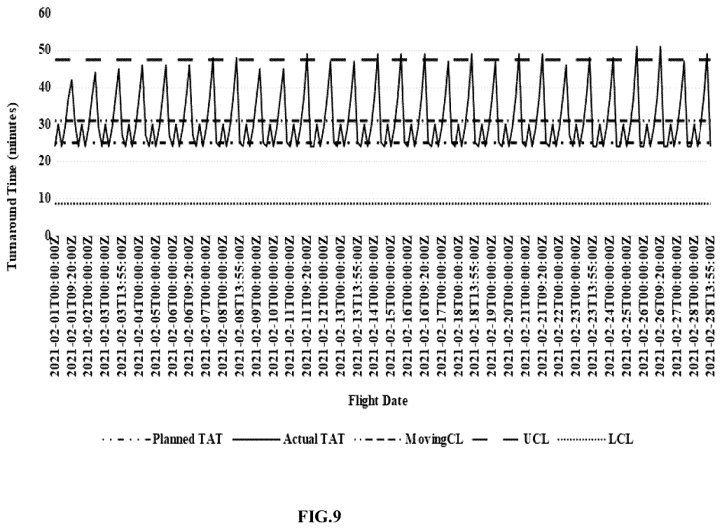

The continuous improvement planner module 310 estimates the statistical control chart daily or weekly or monthly of each flight event which helps segregating the outliers and identify controllable and uncontrollable activities on the respective outliers as represented in the graphical representation of FIG. 9.

FIG. 9 illustrates the outlier analysis for 25 mins quick turnaround process (baseline), which suggests the process was effectively executed at its best within a control range of 21 to 43 mins. The scheduled turnaround time (TAT) value below the actual TAT value obtains the UCL=43 mins, LCL=21 mins, Moving Central Line=32 mins, and standard deviation=4 mins.

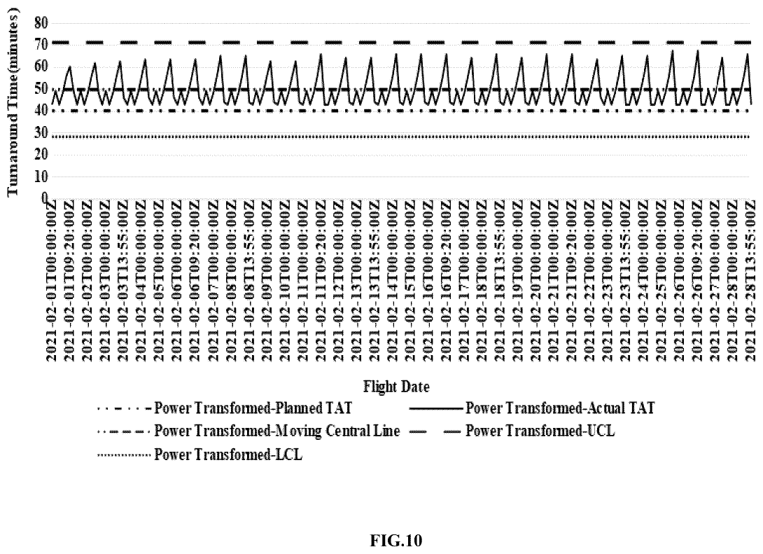

The power transformation (FIG. 10) of the actual TAT value transforms the actual TAT value into a power transformed TAT value with a predefined threshold and compares the statistical control chart between the actual TAT value and the inverse function of the power transformed TAT value. The power transformation of the actual TAT value is the ratio of data points of the actual TAT value with the geometric mean of the historical actual TAT values which is represented in Equation 13,

$$f ( {X}_{i} ) = \frac{( {( {X}_{i} )}^{t} - k )}{t ( {GM ( {X}_{1} , {X}_{2} , … , {X}_{i} )}^{t - k} )} \qquad Equation 13$$

Where, ƒ(Xᵢ) is the transformed value of the actual TAT value
(Xᵢ) is the data points of the actual TAT value
(k) is number of CPM activities
   GM=Geometric mean of the historical data, 0<t<1.
   Equation 13 depicts the transformed or normalized (Gaussian-like) actual TAT value based on the plurality of baseline turnaround parameters, where each critical path activities are modelled to compute corresponding transformed data.

FIG. 10 illustrates graphical representation of power transformation of actual TAT value using the system of FIG. 1, in accordance with some embodiments of the present disclosure. The power transform is a family of functions applied to create monotonic transformation of data using power functions denoted based on the actual TAT values, the power transformation, number of flight events, geometrical mean of the historical actual TAT values. Here, the power parameter ‘t’ (lies between −1 and 1) such a way that the likelihood of transformed data is maximum, and the data are normally distributed when the standard deviation of the data is small. The data transformation technique performs stabilizing variances that makes the data more with normal distribution to improve the validity of measures of coefficient of variation for the plurality of attributes, and for other data stabilization procedures is represented in Table 1,

TABLE 1
Power Transformation

| | BLR 25 - Power |
|---|---|
| BLR 25 | Transformation |
| Planned TAT 25 | Planned TAT 40 |
| Moving CL 30.97 | Moving CL 49.61558 |
| UCL 47.42226 | UCL 71.05664 |
| LCL 8.547129 | LCL 28.17453 |
| FL = Moving CL − Planned | FL = Moving CL − Planned |
| TAT = 5.97 | TAT = 9.61558 |
| Revised UCL = UCL − FL = | Revised UCL = UCL − FL = |
| 41.45226 | 61.44106 |

Inverse transformation of power transformation: (25/40)*61.44106=38.4 mins. To reduce the UCL value from 47.42226 to 38.4 mins when all the data points behave like gaussian or normal distribution. It is to be noted without power transformation the UCL is reduced from 47.42226 to 41.45226 mins, since the data points are not behaving like Gaussian. Hence the power transformation helps to find out optimized UCL value.

Referring now to the steps of the method 300, at step 312, the one or more hardware processors 104 construct a performance chart of each flight event by determining one or more on-time performance parameters (OTP) of each flight event from the statistical control chart and computing a coefficient of variation (CoV) of the OTP based on a ratio of average OTP with the standard deviation of the OTP.

The airlines provide an on-the-go OTP dashboard with a drill down of delay factors and its contribution to OTP slippage. On each day, OTP of all fleets pertaining to airlines is determined by the overall TAT performance is represented in Table 2,

TABLE 2
Performance data

| | OTP | Controllable |
|---|---|---|
| Date | % | % |
| 4th Jun. 2021 | 69 | 6 |
| 5th Jun. 2021 | 72 | 8 |
| — | — | — |

Using the statistical control chart, the Moving Central Line (MCL), the UCL and the LCL of the one or more OTP are determined from the above Table. Coefficient of variation (CoV) of OTP is computed based on the average of the one or more OTP and the standard deviation of the one or more OTP is described below in Equation 14,

$$CoV of OTP = Average of OTP / Standard deviation of OTP \qquad Equation 14$$

The improved OTP is a sum of the OTP and the plurality of influencing controllable factors computing, a one or more uncontrollable activities by estimating the improved OTP (Equation 15) and limitation of the one or more uncontrollable activities based on the maximum OTP and the improved OTP is represented in Equation 15,

$$Improved OTP \% = OTP \% + Controllable \% \qquad Equation 15$$

Further, the one or more uncontrollable activities existing are estimated based on the improved OTP is represented in Equation 16,

$$UC activities \% = ( 100 \% - Improved OTP \% ) \qquad Equation 16$$

The limitation of one or more uncontrollable activities is represented in Equation 17,

$$Limit of UC = Max OTP \% - Improved OTP \% \qquad Equation 17$$

In real-time airlines TAT performance, it is difficult to achieve 100% with unresolved uncontrollable activities. But there may be limitation of uncontrollable activities to be resolved into some extent and the computation for limit needs to be formulated.

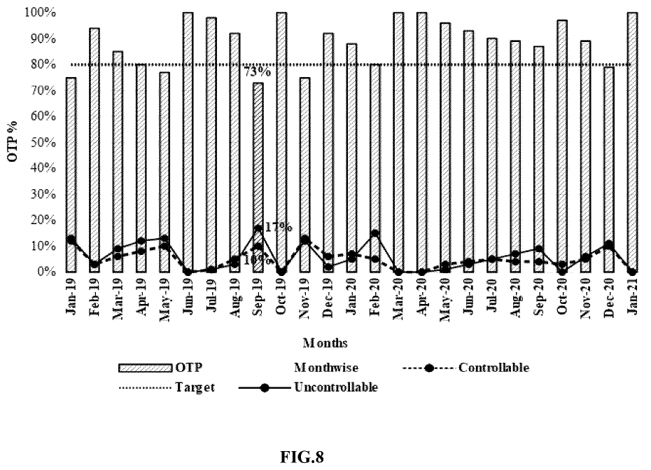

Further, a maximum OTP of each flight event is determined based on (i) the coefficient of variation of the OTP, (ii) an improved OTP, and (iii) the one or more OTP is represented in Equation 18 and as referred in FIG. 8,

$$Max OTP = ( Improved OTP ) * ( CoV of OTP ) + OTP \qquad Equation 18$$

FIG. 8 illustrates graphical representation of on-time performance parameters versus a plurality of controllable activities identified in the flight event using the system of FIG. 1, in accordance with some embodiments of the present disclosure. In the given illustrative data, for the month of Sep. 2019, the achieved OTP is 73% which is below the targeted OTP. However, in the same dashboard the window of opportunity which is 10% is also given. The suggested 10% is a result of contribution by various internal controllable factors. Then the improved OTP becomes 83% above the target level 80%. Still, uncontrollable 17% exists.

Referring now to the steps of the method 300, at step 314, the one or more hardware processors 104 compute a coefficient of association of each flight event between a previous hop of the OTP and the scheduled turnaround time (TAT) value based on a plurality of attributes. Referring now to the above example, after the aircrafts have effectively implemented the continuous improvement plan for enhancing the threshold values and achieving the targeted OTP. Here, Yules' co-efficient of association (YCA) method computes the association between the OTP and the scheduled turnaround time. It measures the strength and direction of association among the attributes. The measurement depicts the significance of outlier's analysis to improve the TAT performance and the below Table 3 represents the contingency Data.

The plurality of attributes includes,
A stands for outlier activities
α stands for non-outlier activities
B stands for controllable activities
β stands for uncontrollable activities
AB stands for outlier activities which are controllable
Aβ stands for outlier activities which are uncontrollable
αB stands for non-outlier activities which are controllable
αβ stands for non-outlier activities which are uncontrollable

TABLE 3
Contingency Data

| | Attribute B | | |
|---|---|---|---|
| Attribute A | Yes B | No β | Total |
| Yes A | (AB) | (Aβ) | (A) |
| No α | (αB) | (αβ) | (α) |
| Total | (B) | (β) | N |

Example data represents controlling the outliers be regarded a preventive measure from the data given below:
1482 fleets in the month of Feb. 2021 at Bangalore (BLR) airport, exposed to outliers, 368 in all outliers, among the 1482 fleets, 343 had been controlled factors among only 35 outliers.
It is to be noted, A denote the attribute of controlling maintenance process, B denote that of outliers, a denotes unable to control maintenance and @ denotes non-outliers (below UCL) as represented below in Table 4,
Among 368 outlier activities, 35 activities—controllable
Among 1482 activities, 343 activities—controllable

TABLE 4
Example data

| | | | |
|---|---|---|---|
| B | 35 | 333 | 368 |
| β | 308 | 806 | 1114 |
| Total | 343 | 1139 | 1482 |

Here, the coefficient of association is represented in Equation 19,

$$YCA = \{ ( A * B ) ( α * β ) - ( A * β ) ( α * B ) \} / \{ ( A * B ) ( α * β ) + \qquad Equation 19$$

$$( A * β ) ( α * B ) \} = - 0.57$$

There is a negative association between outliers and controlling maintenance process. In other words, there is a positive association between non-outliers and uncontrolled. Hence, controlling maintenance or is considered as a preventive measure for the aircraft. Next, obtaining partial correlation that measures the degree of association between the OTP and the TAT value with the effect of a set of controlling CPM activities removed. It is to be noted that partial correlation measures the strength of a relationship between the OTP and the TAT values while controlling the effect of one or more other CPM activities.
Let us consider X₁=OTP, X₂=TAT and X₃=Outliers and determining,
r₁₂=Pearson correlation between X₁ and X₂
r₂₃=Pearson correlation between X₂ and X₃
r₁₃=Pearson correlation between X₁ and X₃
   The partial correlation coefficient estimates the degree of association between X₁=OTP and X₂=TAT, when controlling outliers X₃. It is given by the relationship

$${r}_{12 , 3} = \frac{( {r}_{12} - {r}_{13} {r}_{23} )}{{( 1 - {r}_{13}^{2} )}^{0.5} {( 1 - {r}_{23}^{2} )}^{0.5}}$$

and the derived analytical functions of stages A, B, C and D obtains the optimized results.

Referring now to the steps of the method 300, at step 316, the one or more hardware processors 104 predict at every hop turnaround time operations delay of each flight leg movement based on an air traffic delay model trained with a plurality of air traffic TAT delays.

In one embodiment, the plurality of air traffic TAT delays comprises a TAT delay, an arrival delay, and an uncontrollable delay. The TAT delay includes a next leg TAT delay and a consecutive leg TAT delay, and an average TAT delay value computed from the station level TAT outlier data corresponding to a next leg arrival station.

The arrival delay including a current leg flight data, and the average TAT delay value computed from the station level TAT outlier data of a current leg arrival station.

The uncontrollable delay including the current leg flight data and an average arrival delay value computed from the station level TAT outlier data of a current leg departure station.

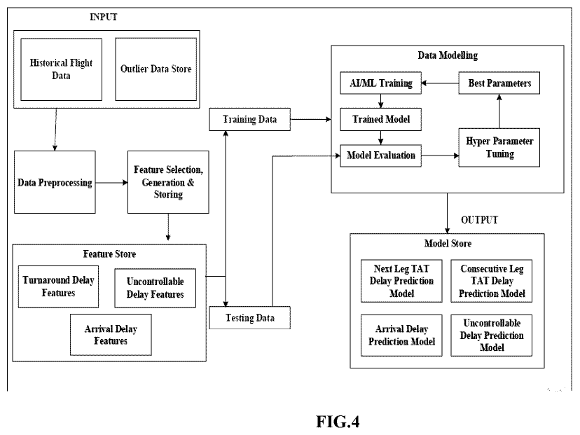

Training the air traffic delay model (FIG. 4) to predict turnaround time operations delay of each flight at every hop by performing the steps of:

Step 1—determine the next leg TAT delay by estimating a plurality of current leg flight factors and a plurality of next leg flight factors.
The plurality of current leg flight factors includes an aircraft type, an aircraft registration number, a day of week, a month, an arrival time slot, an arrival station code, a TAT delay minutes range, and an arrival delay minutes range. The plurality of next leg flight factors includes an arrival station code, a departure time slot, and an arrival time slot.
Step 2—compute the average TAT delay of the next leg arrival station from the station level TAT outlier data of each flight based on an airport code, the day of week, the arrival time slot, a flight route, and the month.
Step 3—determine the consecutive legs TAT delay by estimating a plurality of current leg flight factors and a plurality of next leg flight factors. The plurality of current leg flight data includes the aircraft type, the aircraft registration number, the day of week, the month, the arrival time slot, the arrival station code, and the estimated TAT delay minutes range. The plurality of next leg flight data includes the arrival station code, the departure time slot, and the arrival time slot.
Step 4—determine the arrival delay current leg flight data by estimating the aircraft type, the aircraft registration number, the day of week, the month, the departure time slot, the arrival station code, a departure time slot, and the arrival time slot.
Step 5—compute the average TAT delay value computed from the station level TAT outlier data of current leg arrival station based on the airport code, the day of week, the arrival time slot, the flight route, and the month.
Step 6—determine, the current leg flight data of the uncontrollable delay based on the aircraft type, the aircraft registration number, the day of week, the month, the departure station code, the arrival station code, and the departure time slot.
Step 7—compute the average uncontrollable delay computed from the station level TAT outlier data of current leg departure station based on the airport code, the day of week, the departure time slot, the flight route, and the month.

Referring now to the steps of the method 300, at step 318, the one or more hardware processors 104 predict delays impacting air traffic network at current flight leg based on the turnaround time operations delay and determining scheduling status of each flight event based on a threshold delay for next leg execution by estimating (i) an estimated time of departure (ETD) of current flight leg using the current leg data, (ii) an estimated time of departure (ETD) of current flight leg using the previous flight leg and the current flight leg data, (iii) an estimated time of arrival (ETA) of the current flight leg.

Referring now to the above said example, the flight delay impacting air traffic network at current flight leg are predicted based on a sum of the arrival delay time, delay time in the actual TAT, and the delay time of the plurality of uncontrollable factors is represented in Equation 20,

$$Delay Impact at {Leg}_{N} = {Leg}_{N - 1} ( Arrival delay + TAT delay ) + {Leg}_{N} Uncontrollable delay \qquad Equation 20$$

In one embodiment, estimating the departure time (ETD) of the current flight leg based on the sum of scheduled departure time and the plurality of uncontrollable factors delay of current flight leg is represented in Equation 21,

$${Leg}_{N} ETD = {Leg}_{N} ( Scheduled Time of Departure + Expected Uncontrollable delay ) \qquad Equation 21$$

wherein the previous flight leg is the sum of the arrival delay and the TAT delay value.

In one embodiment, estimating the departure time (ETD) of the current leg based on the sum of scheduled arrival time of the previous leg and the flight leg delay impacting the current trip scheduled for the flight is represented in Equation 22,

$${Leg}_{N} ETD = {Leg}_{N - 1} Schedule Time of Arrival + {Leg}_{N} Delay Impact \qquad Equation 22$$

Where, N=2 to number of trips (hops) scheduled for the flight

In one embodiment, estimating the arrival time (ETA) based on the scheduled arrival time, predicted arrival delay and the plurality of uncontrollable factors delay is represented in Equation 23,

$${Leg}_{N} ETA = {Leg}_{N} ( Schedule Time of Arrival + Predicted Arrival delay + Expected or Actual Uncontrollable delay ) \qquad Equation 23$$

The threshold delay for next flight leg execution helps in taking decisions to execute Leg_{N} or cancelling next flight leg or else executing the historical data of Leg_{N} status to execute or cancel to build the model to predict the Leg_{N} status with the help of Delay Impact on the network along with some more features. The features need to be analyzed. It is to be noted that network optimizer at each flight leg can be considered as node and the delay minutes as each node weightage.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of turnaround time. The embodiment thus provides predicting multi-hop turnaround operations in aircraft. Moreover, the embodiments herein further provides predicting factors influencing the turnaround time for determining next scheduled TAT in consecutive hops of the aircraft journey. The predictor module provides domain level factors impacting decision at each aircraft leg position. The present disclosure has training data and the features of flight event activities in the multi-hop prediction of TAT are influencing factors of the delay gathered through airlines database. The method obtains efficiency and accurate multi-hop prediction with arrival delay for cancelling or execution of the aircraft.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for predicting multi-hop turnaround time operations, the method comprising:
receiving via one or more hardware processors, an input data comprising one or more flight events scheduled between a source and a destination, wherein each flight event includes one or more hops;
determining via the one or more hardware processors, a scheduled turnaround time (TAT) value from outliers of each flight event;
constructing via the one or more hardware processors, a statistical control chart by analyzing the outliers of each flight event based on at least one of (i) if a standard deviation is lower than absolute difference between the baseline TAT value and a moving central line of the actual TAT value by using a plurality of turnaround parameters, and (ii) if the standard deviation exceeds absolute difference between the baseline TAT value and the moving central line of the actual TAT value by using a plurality of baseline turnaround parameters;
determining via the one or more hardware processors, a station level TAT outlier data corresponding to each hop of each flight event based on the statistical control chart;
estimating via the one or more hardware processors, a continuous improvement plan based on (i) the statistical control chart, (ii) a plurality of influencing controllable factors, (iii) a plurality of influencing uncontrollable factors, and (iv) a power transformation of the actual TAT value;
constructing via the one or more hardware processors, a performance chart of each flight event by,
determining one or more on-time performance parameters (OTP) of each flight event from the statistical control chart and computing a coefficient of variation (CoV) of the OTP based on a ratio of average OTP and the standard deviation of the OTP,
determining a maximum OTP of each flight event based on (i) the coefficient of variation of the OTP, (ii) an improved OTP, and (iii) the one or more OTP, wherein the improved OTP is a sum of the OTP and the plurality of influencing controllable factors, and
computing a one or more uncontrollable activities by estimating the improved OTP and limits of the plurality of influencing uncontrollable factors based on the maximum OTP and the improved OTP;
computing via the one or more hardware processors, a coefficient of association of each flight event between a previous hop of the OTP and the scheduled turnaround time (TAT) value based on a plurality of attributes;
predicting via the one or more hardware processors, at every hop turnaround time operations delay of each flight leg movement based on an air traffic delay model trained with a plurality of air traffic TAT delays; and
predicting via the one or more hardware processors, delays impacting air traffic network at current flight leg based on the turnaround time operations delay and determining scheduling status of each flight event based on a threshold delay for next flight leg execution by estimating (i) an estimated time of departure (ETD) of current flight leg using a current flight leg data, (ii) an estimated time of departure time (ETD) of current flight leg using a previous leg data and the current flight leg data, and (iii) an estimated time of arrival (ETA) of the current leg data.

2. The processor implemented method as claimed in claim 1, wherein the plurality of turnaround parameters comprises of a moving central line, an upper control limit and a lower control limit, wherein the upper control limit includes a primary UCL₁ and a secondary UCL₂ and the lower control limit includes a primary LCL₁ and a secondary LCL₂.

3. The processor implemented method as claimed in claim 1, wherein the plurality of baseline turnaround parameters comprises of a baseline upper control limit (UCL) and a baseline lower control limit (LCL), wherein baseline upper control limit (UCL) includes a first UCL₁ value, a second UCL₂ value, a third UCL₃ value, and a fourth UCL₄ value, and the baseline lower control limit (LCL) includes a first LCL₁ value, a second LCL₂ value, a third LCL₃ value, and a fourth LCL₄ value.

4. The processor implemented method as claimed in claim 1, wherein constructing the statistical control chart for the scheduled turnaround time (TAT) value below the actual TAT value by performing the steps of:
computing, the primary upper control limit (UCL) based on a mean value of the actual TAT value summed with a ratio of moving range mean value of a predefined value, and the secondary upper control limit (UCL) is a mean value summed with a predefined number of times of standard deviation; and
computing, the primary lower control limit (LCL) based on a difference between a baseline TAT value with the ratio of moving range mean value of the predefined value, and the secondary lower control limit (LCL) is the difference between the actual TAT mean value and the predefined number of times of standard deviation.

5. The processor implemented method as claimed in claim 1, wherein constructing the statistical control chart for the scheduled turnaround time (TAT) value above the actual TAT value by performing the steps of:
computing the first UCL value based on the actual TAT mean value summed with the ratio of moving range mean value and the predefined value, the second UCL value is the actual TAT mean value summed with the standard deviation, the third UCL value is the baseline TAT value summed with the ratio of moving range mean value of the predefined value, and the fourth UCL value is the baseline value summed with the standard deviation; and
computing the first LCL value based on the difference between the actual TAT mean value and the ratio of moving range mean value with the predefined value, the second LCL value is the mean value difference with the standard deviation, the third LCL value is the difference between baseline TAT value with the ratio of moving range mean value of the predefined value, and the fourth LCL value is the difference between the baseline TAT value and the predefined number of times of standard deviation.

6. The processor implemented method as claimed in claim 1, wherein the transformation function transforms the actual TAT value into a power transformed TAT value with a predefined threshold and compares the statistical control chart between the actual TAT value and the inverse function of the power transformed TAT value.

7. The processor implemented method as claimed in claim 1, wherein the plurality of air traffic TAT delays comprises:
a TAT delay including a next leg TAT delay and a consecutive leg TAT delay, and an average TAT delay value computed from the station level TAT outlier data corresponding to a next leg arrival station,
an arrival delay including a current leg flight data, and the average TAT delay value computed from the station level TAT outlier data of a current leg arrival station, and
an uncontrollable delay including the current leg flight data and an average arrival delay value computed from the station level TAT outlier data of a current leg departure station.

8. The processor implemented method as claimed in claim 1, wherein training the air traffic delay model to predict turnaround time operations delay of each flight at every hop by,
determining the next leg TAT delay by estimating a plurality of current leg flight factors and a plurality of next leg flight factors, wherein the plurality of current leg flight factors includes an aircraft type, an aircraft registration number, a day of week, a month, an arrival time slot, an arrival station code, a TAT delay minutes range, and an arrival delay minutes range, wherein the plurality of next leg flight factors includes an arrival station code, a departure time slot, and an arrival time slot;
computing the average TAT delay of the next leg arrival station from the station level TAT outlier data of each flight based on an airport code, the day of week, the arrival time slot, a flight route, and the month;
determining the consecutive legs TAT delay by estimating a plurality of current leg flight factors and a plurality of next leg flight factors, wherein the plurality of current leg flight data includes the aircraft type, the aircraft registration number, the day of week, the month, the arrival time slot, the arrival station code, and the estimated TAT delay minutes range, wherein the plurality of next leg flight data includes the arrival station code, the departure time slot, and the arrival time slot;
determining the arrival delay current leg flight data by estimating the aircraft type, the aircraft registration number, the day of week, the month, the departure time slot, the arrival station code, a departure time slot, and the arrival time slot;
computing the average TAT delay value computed from the station level TAT outlier data of current leg arrival station based on the airport code, the day of week, the arrival time slot, the flight route, and the month;
determining the current leg flight data of the uncontrollable delay based on the aircraft type, the aircraft registration number, the day of week, the month, the departure station code, the arrival station code, and the departure time slot; and
computing the average uncontrollable delay computed from the station level TAT outlier data of current leg departure station based on the airport code, the day of week, the departure time slot, the flight route, and the month.

9. The processor implemented method as claimed in claim 1, predicting flight delay impacting air traffic network at current flight leg based on the sum of a previous flight leg and the current flight leg uncontrollable delay, wherein the previous leg is the sum of the arrival delay and the TAT delay value.

10. The processor implemented method as claimed in claim 1, wherein estimating the time of departure (ETD) of the current leg based on the sum of scheduled time of departure and the plurality of uncontrollable factors delay of the current leg.

11. The processor implemented method as claimed in claim 1, estimating the time of departure (ETD) of the current leg based on the sum of scheduled arrival time of the previous leg and the flight leg delay impacting the current trip scheduled for the flight.

12. The processor implemented method as claimed in claim 1, estimating the time of arrival (ETA) based on the scheduled arrival time, predicted arrival delay and the plurality of uncontrollable factors delay.

13. A system (100) for predicting multi-hop turnaround time operations, comprising:
a memory (102) storing instructions;
one or more communication interfaces (106); and
one or more hardware processors (104) coupled to the memory (102) via the one or more communication interfaces (106), wherein the one or more hardware processors (104) are configured by the instructions to:
receive an input data comprising one or more flight events scheduled between a source and a destination, wherein each flight event includes one or more hops;
determine a scheduled turnaround time (TAT) value from outliers of each flight event;
construct a statistical control chart by analyzing the outliers of each flight event based on at least one of (i) if a standard deviation is lower than absolute difference between the baseline TAT value and a moving central line of the actual TAT value by using a plurality of turnaround parameters, and (ii) if the standard deviation exceeds absolute difference between the baseline TAT value and the moving central line of the actual TAT value by using a plurality of baseline turnaround parameters;
determine a station level TAT outlier data corresponding to each hop of each flight event based on the statistical control chart;
estimate a continuous improvement plan based on (i) the statistical control chart, (ii) a plurality of influencing controllable factors, (iii) a plurality of influencing uncontrollable factors, and (iv) a power transformation of the actual TAT value;
construct a performance chart of each flight event by,
determining one or more on-time performance parameters (OTP) of each flight event from the statistical control chart and computing a coefficient of variation (CoV) of the OTP based on a ratio of average OTP and a standard deviation of the OTP,
determining a maximum OTP of each flight event based on (i) the coefficient of variation of the OTP, (ii) an improved OTP, and (iii) the one or more OTP, wherein the improved OTP is a sum of the OTP and the plurality of influencing controllable factors, and
computing a one or more uncontrollable activities by estimating the improved OTP and limits of the plurality of influencing uncontrollable factors based on the maximum OTP and the improved OTP;
compute a coefficient of association of each flight event between a previous hop of the OTP and the scheduled turnaround time (TAT) value based on a plurality of attributes;
predict at every hop turnaround time operations delay of each flight leg movement based on an air traffic delay model trained with a plurality of air traffic TAT delays; and
predict delays impacting air traffic network at current flight leg based on the turnaround time operations delay and determining scheduling status of each flight event based on a threshold delay for next flight leg execution by estimating (i) an estimated time of departure (ETD) of current flight leg using a current flight leg data, (ii) an estimated time of departure time (ETD) of current flight leg using a previous leg data and the current flight leg data, and (iii) an estimated time of arrival (ETA) of the current leg data.

14. The system as claimed in claim 13, wherein constructing the statistical control chart if the standard deviation lower than absolute difference by performing the steps of:
compute the primary upper control limit (UCL) based on a mean value of the actual TAT value summed with a ratio of moving range mean value of a predefined value, and the secondary upper control limit (UCL) is a mean value summed with a predefined number of times of standard deviation; and
compute the primary lower control limit (LCL) based on a difference between a baseline TAT value with the ratio of moving range mean value of the predefined value, and the secondary lower control limit (LCL) is the difference between the actual TAT mean value and the predefined number of times of standard deviation.

15. The system as claimed in claim 13, wherein constructing the statistical control chart if the standard deviation exceeding absolute difference between the baseline TAT value and the moving central line of the actual TAT value by performing the steps of:
compute the first UCL value based on the actual TAT mean value summed with the ratio of moving range mean value and the predefined value, the second UCL value is the actual TAT mean value summed with the standard deviation, the third UCL value is the baseline value summed with the ratio of moving range mean value and the predefined value, and the fourth UCL value is the baseline value summed with the standard deviation; and
compute the first LCL value based on the difference between the actual TAT mean value and the ratio of moving range mean value with the predefined value, the second LCL value is the mean value difference with the standard deviation, the third LCL value is the difference between baseline value and the ratio of moving range mean value and the predefined value, and the fourth LCL value is the difference between the baseline TAT value and the predefined number of times of standard deviation.

16. The system as claimed in claim 13, wherein training the air traffic delay model to predict turnaround time operations delay of each flight at every hop by,
determine the next leg TAT delay by estimating a plurality of current leg flight factors and a plurality of next leg flight factors, wherein the plurality of current leg flight factors includes an aircraft type, an aircraft registration number, a day of week, a month, an arrival time slot, an arrival station code, a TAT delay minutes range, and an arrival delay minutes range, wherein the plurality of next leg flight factors includes an arrival station code, a departure time slot, and an arrival time slot;
compute the average TAT delay of the next leg arrival station from the station level TAT outlier data of each flight based on an airport code, the day of week, the arrival time slot, a flight route, and the month;
determine the consecutive legs TAT delay by estimating a plurality of current leg flight factors and a plurality of next leg flight factors, wherein the plurality of current leg flight data includes the aircraft type, the aircraft registration number, the day of week, the month, the arrival time slot, the arrival station code, and the estimated TAT delay minutes range, wherein the plurality of next leg flight data includes the arrival station code, the departure time slot, and the arrival time slot;
determine the arrival delay current leg flight data by estimating the aircraft type, the aircraft registration number, the day of week, the month, the departure time slot, the arrival station code, a departure time slot, and the arrival time slot;
compute the average TAT delay value computed from the station level TAT outlier data of current leg arrival station based on the airport code, the day of week, the arrival time slot, the flight route, and the month;
determine the current leg flight data of the uncontrollable delay based on the aircraft type, the aircraft registration number, the day of week, the month, the departure station code, the arrival station code, and the departure time slot; and
compute the average uncontrollable delay computed from the station level TAT outlier data of current leg departure station based on the airport code, the day of week, the departure time slot, the flight route, and the month.

17. The system as claimed in claim 13, predicting flight delay impacting air traffic network at current flight leg based on the sum of a previous leg and the current leg uncontrollable delay, wherein the previous leg factor is the sum of the arrival delay and the TAT delay value.

18. The system as claimed in claim 13, wherein estimating the time of departure time (ETD) of the current leg based on the sum of scheduled time of departure and the plurality of uncontrollable factors delay.

19. The system as claimed in claim 13, estimating the time of departure (ETD) of the current leg based on the sum of scheduled arrival time of the previous leg and the flight leg delay impacting the current trip scheduled for the flight, wherein estimating the time of arrival (ETA) based on the scheduled arrival time, predicted arrival delay and the plurality of uncontrollable factors delay.

20. One or more non-transitory machine-readable information storage mediums comprising one or more instructions which when executed by one or more hardware processors cause:
receiving an input data comprising one or more flight events scheduled between a source and a destination, wherein each flight event includes one or more hops;
determining a scheduled turnaround time (TAT) value from outliers of each flight event;
constructing a statistical control chart by analyzing the outliers of each flight event based on at least one of (i) if a standard deviation is lower than absolute difference between the baseline TAT value and a moving central line of the actual TAT value by using a plurality of turnaround parameters, and (ii) if the standard deviation exceeds absolute difference between the baseline TAT value and the moving central line of the actual TAT value by using a plurality of baseline turnaround parameters;
determining a station level TAT outlier data corresponding to each hop of each flight event based on the statistical control chart;
estimating a continuous improvement plan based on (i) the statistical control chart, (ii) a plurality of influencing controllable factors, (iii) a plurality of influencing uncontrollable factors, and (iv) a power transformation of the actual TAT value;
constructing a performance chart of each flight event by,
determining one or more on-time performance parameters (OTP) of each flight event from the statistical control chart and computing a coefficient of variation (CoV) of the OTP based on a ratio of average OTP and the standard deviation of the OTP,
determining a maximum OTP of each flight event based on (i) the coefficient of variation of the OTP, (ii) an improved OTP, and (iii) the one or more OTP, wherein the improved OTP is a sum of the OTP and the plurality of influencing controllable factors, and
computing a one or more uncontrollable activities by estimating the improved OTP and limits of the plurality of influencing uncontrollable factors based on the maximum OTP and the improved OTP;
computing a coefficient of association of each flight event between a previous hop of the OTP and the scheduled turnaround time (TAT) value based on a plurality of attributes;
predicting at every hop turnaround time operations delay of each flight leg movement based on an air traffic delay model trained with a plurality of air traffic TAT delays; and
predicting delays impacting air traffic network at current flight leg based on the turnaround time operations delay and determining scheduling status of each flight event based on a threshold delay for next flight leg execution by estimating (i) an estimated time of departure (ETD) of current flight leg using a current flight leg data, (ii) an estimated time of departure time (ETD) of current flight leg using a previous leg data and the current flight leg data, and (iii) an estimated time of arrival (ETA) of the current leg data.
